(19) United States
(12) Patent Application Publication
(10) Pub. No.: US 2011/0116058 A1
(43) Pub. Date: May 19, 2011

(54) PRINTER AND PRINTING METHOD FOR LENTICULAR SHEET

(76) Inventors: Takeshi OTA, Saitama (JP); Yoichi SAWACHI, Saitama (JP)

(21) Appl. No.: 12/948,491

(22) Filed: Nov. 17, 2010

(30) Foreign Application Priority Data
Nov. 18, 2009 (JP) 2009-262916

(51) Int. Cl. G03B 35/14

(52) U.S. Cl. 355/22

(57) ABSTRACT

A lenticular sheet includes an array of lenticules and a back surface located opposite to the lenticules. In a printer, a printhead prints plural interlaced images on the back surface, the interlaced images being formed by interlacing two original images having disparity. A line sensor has plural sensor elements arranged in an array direction of the lenticules, and receives detection light condensed by a cylindrical lens, to output a detection signal for representing a vertex point of the lenticules. A transport device transports the lenticular sheet in the array direction, and adjusts an orientation of the lenticular sheet during transport to remove offset of the lenticular sheet from the array direction. A controller controls the transport device according to the detection signal, sets a longitudinal direction of the lenticules perpendicular to the array direction by adjusting the orientation, and drives the printhead for printing.

### BACKGROUND OF THE INVENTION

1. Field of the Invention

The present invention relates to a printer and printing method for a lenticular sheet. More particularly, the present invention relates to a printer and printing method for a lenticular sheet, in which plural original images for a three dimensional image can be printed with high precision on the lenticular sheet.

2. Description Related to the Prior Art

A lenticular sheet includes an array of lenticules or semi cylindrical lens elements arranged on a lens surface as a first surface in parallel with one another. Aback surface as a second surface of the lenticular sheet is flat. Also, a three dimensional print is known, in which an image is printed on the back surface of the lenticular sheet for viewing a three dimensional image. The image is constituted of two or more original images having disparity according to photography with two camera units positioned horizontally. Numerous stripe-shaped interlaced images are created from the original images, and positioned to extend in the longitudinal direction of the lenticules. When a viewer views the three dimensional print on the side of the lens surface of the lenticular sheet, right and left eyes of the viewer can see the interlaced images with disparity by use of the lenticules, to recognize the three dimensional image.

The interlaced images must be precisely positioned and printed with respect to the lenticules. In an ink jet printer of JP-A 9-015766, plural layer separators are disposed on the back surface of the lenticular sheet, arranged in an array direction of the lenticules, for separating the lenticules in their longitudinal direction. While the lenticular sheet is transported in the array direction of the lenticules, the layer separators are detected by a pitch detector. A transport mechanism for transporting the lenticular sheet is controlled according to a result of the detection.

In JP-A 7-261120, two sensor systems are used for manufacturing a lenticular display. Each of the sensor systems includes a light source and a sensor camera. The light source emits detection light from a side of the lens surface of the lenticular sheet. The sensor camera detects the detection light transmitted through the lenticules on a side of the back surface. Information of a position and an inclination of the lenticules in the lenticular sheet is detected with respect to the array direction of the lenticules. A light-tight housing of the sensor camera includes a lens and a line sensor. The lens condenses the detection light passed through the lenticular sheet. The line sensor detects the detection light condensed by the lens.

In JP-A 9-015766, the layer separators of a form of the plural ridges are disposed on the back surface of the lenticular sheet. The thermal recording in which a printhead directly contacts a recording medium, such as thermal transfer printing, cannot be combined with the structure of the document.

In JP-A 7-261120, the sensor camera for detecting the detection light passed through the lenticular sheet is distant from the back surface of the lenticular sheet. When the detection light travels from the back surface of the lenticular sheet, diffusion of the detection light occurs to lower an amount of light received by the line sensor. Precision of detecting an orientation of the lenticular sheet decreases.

For printing on the recording medium of a sheet shape, a line printer is generally used, in which the recording medium is transported in a sub scan direction, and an image is printed by one line in a main scan direction during the transport. However, JP-A 7-261120 does not disclose detection of an orientation of the lenticular sheet in a line printer, or adjustment of the orientation. The lenticular sheet for use in the three dimensional print is so precise that a number of the lenticules in the arrangement is 100 lpi (lines per rich). Although the adjustment of the orientation of the lenticular sheet must be very fine, there is no known technique for detection and adjustment of an orientation of the lenticular sheet in a correlated manner.

### SUMMARY OF THE INVENTION

In view of the foregoing problems, an object of the present invention is to provide a printer and printing method for a lenticular sheet, in which plural original images for a three dimensional image can be printed with high precision on the lenticular sheet.

In order to achieve the above and other objects and advantages of this invention, a printer for printing with a lenticular sheet including an array of plural lenticules and a back surface located opposite to the lenticules is provided. A transport device transports the lenticular sheet in a transport channel extending in a first direction, the transport device being adapted to correcting an orientation of the lenticular sheet to align the lenticules with a second direction perpendicular to the first direction. A printhead prints plural interlaced images on the back surface in a second direction in the lenticular sheet through the transport channel, the interlaced images being formed by interlacing two or more original images having disparity. A projecting light source applies slit-shaped detection light extending in the second direction to the lenticules of the lenticular sheet in the transport channel. A plano-convex cylindrical lens is disposed opposite to the projecting light source with respect to the transport channel, having a convex surface and a plano surface, the convex surface extending in the second direction, the plano surface being opposed to the back surface. A pressure unit firmly presses the back surface on the plano surface. A line sensor has plural sensor elements arranged in the first direction, for receiving detection light condensed by the cylindrical lens, to output a detection signal for representing a vertex point of the lenticules. A controller controls the transport device according to the detection signal, for correcting the orientation, and for controlling the printhead for printing.

The projecting light source applies the detection light to plural adjacent lenticules among the lenticules. The cylindrical lens condenses two or more detection light components obtained by splitting the detection light with the adjacent lenticules. The line sensor receives the detection light components being condensed, and outputs the detection signal to represent the vertex point of the adjacent lenticules.

The transport device transports the lenticular sheet intermittently, and the printhead accesses to the lenticular sheet while the lenticular sheet is stopped.

The transport device includes a right transport unit for transporting a right portion of the lenticular sheet. A left transport unit transports a left portion of the lenticular sheet, and for operating discretely from the right transport unit.

The controller sets a difference in an amount of transport between the right and left transport units according to the detection signal obtained while the lenticular sheet is stopped, to correct the orientation.

The right and left transport units are pairs of transport rollers for nipping the lenticular sheet.

The projecting light source and the cylindrical lens are positioned to face respectively first and second edge portions of the lenticular sheet in the longitudinal direction. The line sensor is constituted by first and second pairs of line sensors opposed to respectively first and second ends of the cylindrical lens. The controller determines a direction and angle of an inclination relative to the longitudinal direction according to the detection signal from the first and second pairs, and controls the transport device according to the determined direction and angle.

A combination of the projecting light source, the cylindrical lens and the line sensor is opposed to each of first and second edge portions of the lenticular sheet in the longitudinal direction. The controller controls the transport device according to the detection signal output by respectively the line sensor, and matches the vertex point between the first and second edge portions in the array direction.

In one preferred embodiment, the controller finely rotates the lenticular sheet at a fine pitch in a two-dimensional plane defined by the longitudinal direction and the array direction, detects a full width at half maximum of the detection signal, compares values of the full width at half maximum between time points before and after fine rotation of the lenticular sheet, repeats the fine rotation, detection of the full width at half maximum and comparison of the values, then changes over a direction of the fine rotation according to the comparison, and adjusts the orientation during the transport by minimizing the full width at half maximum.

In another preferred embodiment, the controller finely rotates the lenticular sheet at a fine pitch in a two-dimensional plane defined by the longitudinal direction and the array direction, detects an interval between vertex points of two of the lenticules according to the detection signal, compares values of the vertex point interval between time points before and after fine rotation of the lenticular sheet, repeats the fine rotation, detection of the vertex point interval and comparison of the values, then changes over a direction of the fine rotation according to the comparison, and adjusts the orientation during the transport by minimizing the vertex point interval.

In one preferred embodiment, the controller determines a region of one of the lenticules according to a position of the sensor elements in the line sensor and the detection signal of a relationship between outputs of the sensor elements, determines first and second sensor elements of which signals at a highest signal level and a second highest signal level are output in the region, obtains a first tangent passing points of signal levels of the first sensor element and a third sensor element disposed adjacent thereto, and a second tangent passing points of signal levels of the second sensor element and a fourth sensor element disposed adjacent thereto, and retrieves the vertex point of the one lenticule from an intersection point between the first and second tangents.

The detection light has a wavelength equal to or more than 600 nm and equal to or less than 1,000 nm.

The controller counts a number of passed ones of the lenticules according to the detection signal to obtain a position of the lenticular sheet, and determines a start position for printing.

The controller determines a data region for one of the interlaced images according to a waveform of the detection signal.

The controller determines a peak value from the waveform according to one of the lenticules in the detection signal, multiplies the peak value by at least one coefficient determined according to a number of the interlaced images per the one lenticule, and determines the data region for the one interlaced image according to a sensor element position of one of the sensor elements in association with a signal level obtained from a result of multiplication.

In still another preferred embodiment, the controller determines a peak point with a highest signal level and first and second points between which the peak point is disposed and which has a lowest signal level, from the waveform according to one of the lenticules in the detection signal, then equally divides a section between the first point and the peak point and a section between the second point and the peak point, and determines the data region for the one interlaced image.

The pressure unit constitutes a platen device for supporting the lenticular sheet during printing of the printhead to the back surface.

The printhead operates according to transfer recording.

The transfer recording is thermal transfer recording for use with thermal transfer ink film.

Also, a printing method for a lenticular sheet including an array of plural lenticules and a back surface located opposite to the lenticules is provided. In the printing method, slit-shaped detection light is applied toward the lenticules in a longitudinal direction thereof in transporting the lenticular sheet in an array direction of the lenticules crosswise to the longitudinal direction. A detection signal for representing a vertex point of the lenticules is output by condensing the detection light with a plano-convex cylindrical lens and by receiving the detection light with a line sensor, the cylindrical lens being aligned with the lenticules, and so disposed that a plano surface opposite to a convex surface thereof is flush with the back surface being passed, the line sensor having plural sensor elements arranged in the array direction. An orientation of the lenticular sheet during transport is adjusted to set the longitudinal direction perpendicular to the array direction according to the detection signal. Plural interlaced images are printed on the back surface in the longitudinal direction, the interlaced images being formed by interlacing two or more original images having parallax.

The detection light is applied to plural adjacent lenticules among the lenticules. The cylindrical lens condenses two or more detection light components obtained by diffusion of the detection light with the adjacent lenticules. The line sensor receives the detection light components being condensed, and outputs the detection signal to represent the vertex point of the adjacent lenticules.

Thus, plural original images for a three dimensional image can be printed with high precision on the lenticular sheet, because the line sensor, cylindrical lens and the like cooperate for remove offset of the lenticular sheet for good positioning.

### BRIEF DESCRIPTION OF THE DRAWINGS

The above objects and advantages of the present invention will become more apparent from the following detailed description when read in connection with the accompanying drawings, in which:

FIG. 1 is an explanatory view illustrating a printer for a lenticular sheet;

FIG. 2 is a perspective view illustrating the lenticular sheet;

FIG. 3 is a front elevation illustrating a transport device;

FIG. 4 is a side elevation illustrating an image forming assembly;

FIG. 5 is a plan, partially broken, illustrating thermal transfer ink film;

FIG. 6 is a front elevation illustrating an orientation detector;

FIG. 7 is an explanatory view in front elevation, illustrating a detection unit;

FIG. 8 is a front elevation illustrating the detection unit;

FIG. 9 is a graph illustrating a detection signal;

FIG. 10 is a plan, partially broken, illustrating detection of lenticules with a line sensor;

FIG. 11 is a graph illustrating a difference between detection signals from line sensors;

FIG. 12 is a graph illustrating operation of determining a fine region by use of multiplication of coefficients;

FIG. 13 is a graph illustrating operation of determining a fine region by use of division of detection signals;

FIG. 14 is a graph illustrating operation of determining a vertex point with a line sensor of a large pitch of sensor elements;

FIG. 15 is a flow chart illustrating a sequence of detecting and adjusting an orientation of the lenticular sheet;

FIG. 16 is a front elevation illustrating another preferred orientation detector;

FIG. 17 is a side elevation illustrating another preferred detection unit;

FIG. 18 is a graph illustrating a detection signal;

FIG. 19 is a front elevation illustrating still another preferred orientation detector;

FIG. 20 is a flow chart illustrating a sequence of detecting and adjusting an orientation of the lenticular sheet;

FIG. 21 is a flow chart illustrating another preferred sequence of detection and adjustment in which an interval between peak values is used.

### DETAILED DESCRIPTION OF THE PREFERRED EMBODIMENT(S) OF THE PRESENT INVENTION

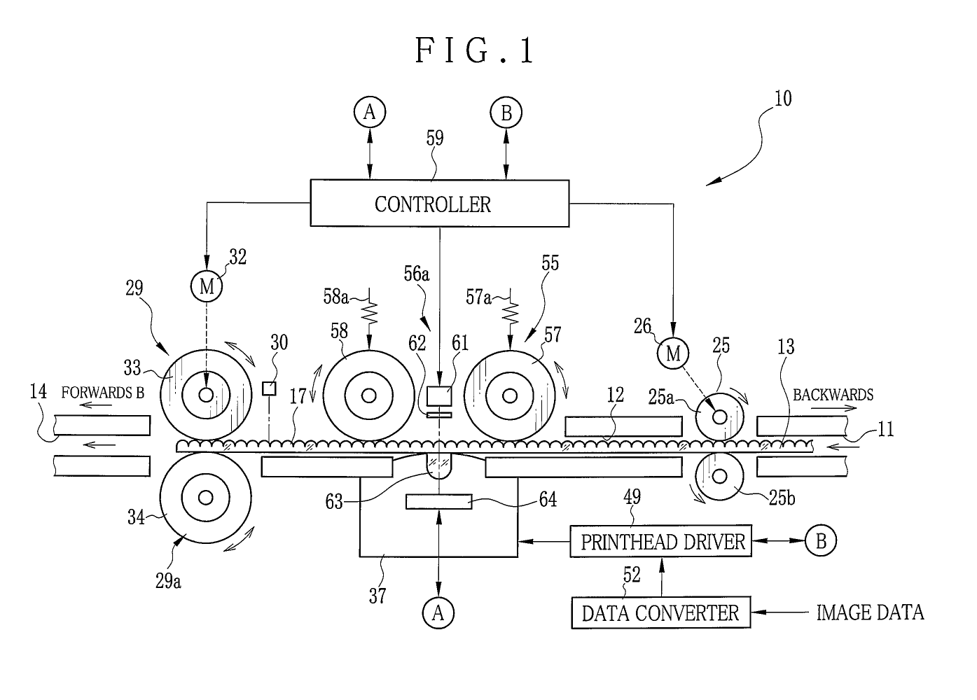

In FIG. 1, a printer 10 of the invention includes an inlet slot 11, a transport channel 12 and an exit slot 14. A lenticular sheet 13 is supplied through the inlet slot 11, and moved through the transport channel 12 toward the exit slot 14. The printer 10 produces a three dimensional image by printing stripe-shaped interlaced images on the lenticular sheet 13. The interlaced images are formed by slicing at least two original images created with parallax. The three dimensional image is exited through the exit slot 14 to the outside of the printer 10.

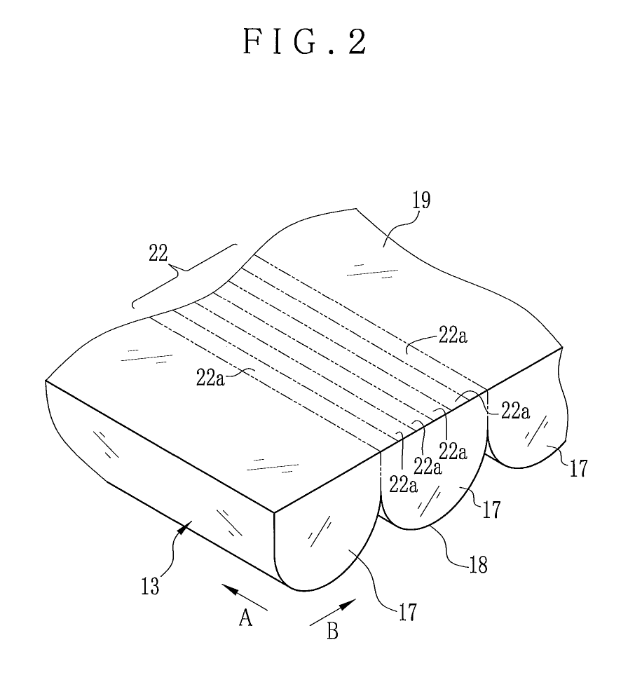

In FIG. 2, the lenticular sheet 13 is formed from transparent plastic material. The lenticular sheet 13 includes lenticules 17 or semi cylindrical lens elements, and has a lens surface 18 as a first surface and aback surface 19 as a second surface. The lens surface 18 is a side of the lenticules 17 arranged in parallel with one another. The back surface 19 is opposite to the lens surface 18. The lenticules 17 are long in the direction A of the arrow. The lenticules 17 are arranged in an array direction B at a density of 100 lpi (lines per inch) in a manner adjacent with one another. Thus, a width of the lenticules 17 and their pitch in the array direction are 254 microns.

Linear regions 22 are defined on the back surface 19 of the lenticular sheet 13 in a virtual manner respectively for the lenticules 17. Six stripe-shaped data regions 22a are present in each of the linear regions 22 according to the number of the original images. The interlaced images formed by slicing the six original images are printed in respectively the data regions 22a. The three dimensional print is viewed from the side of the lens surface 18 of the lenticular sheet 13 as the lenticules 17 while the array direction of the lenticules 17 is set horizontal in viewing of a viewer. Right and left eyes of a viewer view the interlaced images with parallax through the lenticules 17, and thus can see a three dimensional image.

In FIG. 1, the lenticular sheet 13 is supplied through the inlet slot 11 into the transport channel 12 in the array direction of the lenticules 17. The lens surface 18 of the lenticular sheet 13 is directed upwards. For example, a cassette is used to store a stack of the numerous lenticular sheets 13. A supply mechanism well-known in the art automatically supplies the transport channel 12 with the lenticular sheet 13 from the cassette. Note that the lenticular sheet 13 can be inserted in the inlet slot 11 manually in place of the automated construction.

Supply rollers 25 are disposed in the transport channel 12 near to the inlet slot 11. The supply rollers 25 include a capstan roller 25a and a pinch roller 25b. A supply motor 26 drives the capstan roller 25a. The pinch roller 25b cooperates with the capstan roller 25a to nip the lenticular sheet 13. The supply rollers 25 rotate in contacting the lenticular sheet 13, and transport the lenticular sheet 13 toward the transport channel 12. A lifting mechanism (not shown) moves the pinch roller 25b between a closed position and an open position. The pinch roller 25b, when in the closed position, nips the lenticular sheet 13, and when in the open position, releases the lenticular sheet 13.

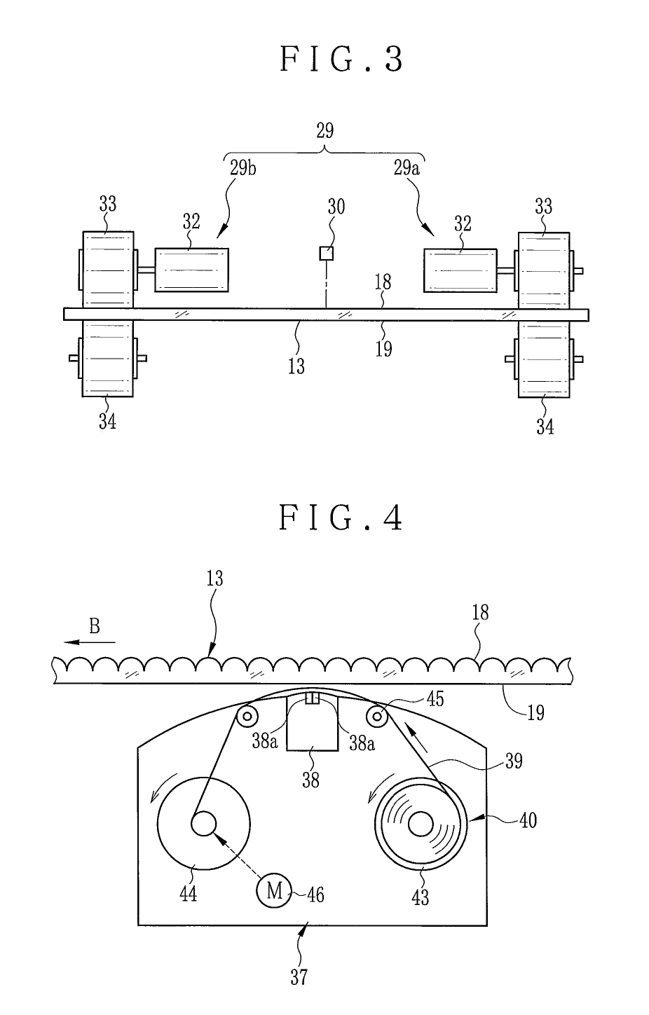

A transport device 29 is disposed in the transport channel 12 near to the exit slot 14. In FIG. 3, the transport device 29 is viewed through the exit slot 14, and includes two transport roller sets 29a and 29b and an end sensor 30. Each of the transport roller sets 29a and 29b is a transport unit opposed to one of two lateral edge portions of the lenticular sheet 13 in the direction crosswise to the transport of the lenticular sheet 13.

The transport roller set 29a includes a capstan roller 33 and a pinch roller 34. A transport motor 32 drives the capstan roller 33. The pinch roller 34 cooperates with the capstan roller 33 to nip the lenticular sheet 13. The transport motor 32 is a stepping motor and causes the capstan roller 33 to rotate continuously or intermittently. The capstan roller 33 and the pinch roller 34 are rollers of rubber for frictional contact with the lenticular sheet 13 without unwanted slip. The pinch roller 34 is shifted by a lifting mechanism (not shown), and when in a closed position, nips the lenticular sheet 13, and when in an open position, releases the lenticular sheet 13. The transport roller set 29b is structurally the same as the transport roller set 29a, and is disposed symmetrically with respect to the array direction of the lenticular sheet 13.

The transport roller sets 29a and 29b nip the lenticular sheet 13 and rotate in synchronism, and when rotated in a forward direction, moves the lenticular sheet 13 from the inlet slot 11 to the exit slot 14, and when rotated in a backward direction, moves the lenticular sheet 13 from the exit slot 14 to the inlet slot 11. Furthermore, the transport roller set 29b is caused to rotate at a different speed from the transport roller set 29a to move lateral edges of the lenticular sheet 13 with rates different from one another. This is effective in finely rotating the lenticular sheet 13 about an axis (normal line) which is perpendicular a two-dimensional plane tangential to the lens surface 18. In short, it is possible to transport the lenticular sheet 13 and adjust its orientation in the transport.

The end sensor 30 is an optical sensor for detecting a distal end of the lenticular sheet 13 supplied into the transport channel 12 by the supply rollers 25. Nipping of the lenticular sheet 13 with the transport roller sets 29a and 29b is carried out in response to detection of the distal end of the lenticular sheet 13 with the end sensor 30.

An image forming assembly 37 is disposed under the transport channel 12 between the supply rollers 25 and the transport device 29. In FIG. 4, the image forming assembly 37 includes a printhead 38 or thermal head and a film supply device 40. The printhead 38 transfers dots of ink to the back surface 19 of the lenticular sheet 13 for image forming. Thermal transfer ink film 39 as recording medium is supplied by the film supply device 40 and becomes superimposed on the back surface 19.

The printhead 38 is disposed in an upper space of the image forming assembly 37 for contacting the back surface 19, and operates for thermal recording of a heat transfer type. Two heating element arrays 38a are disposed on an upper surface of the printhead 38 and arranged in the sub scan direction. In each of the heating element arrays 38a, a great number of heating elements are arranged linearly in the main scan direction, which is crosswise to an array direction of the lenticular sheet 13 or sub scan direction. A length of the heating element arrays 38a is approximately equal to a width of a recording area of the lenticular sheet 13 in the main scan direction. A size of one pixel in the sub scan direction to be recorded by one element is approximately 20 microns. An interlaced image can be recorded in one of the data regions 22a by image forming of the heating element arrays 38a at one time. Note that a single heating element array 38a can be included in the printhead 38 so that images can be recorded by one line.

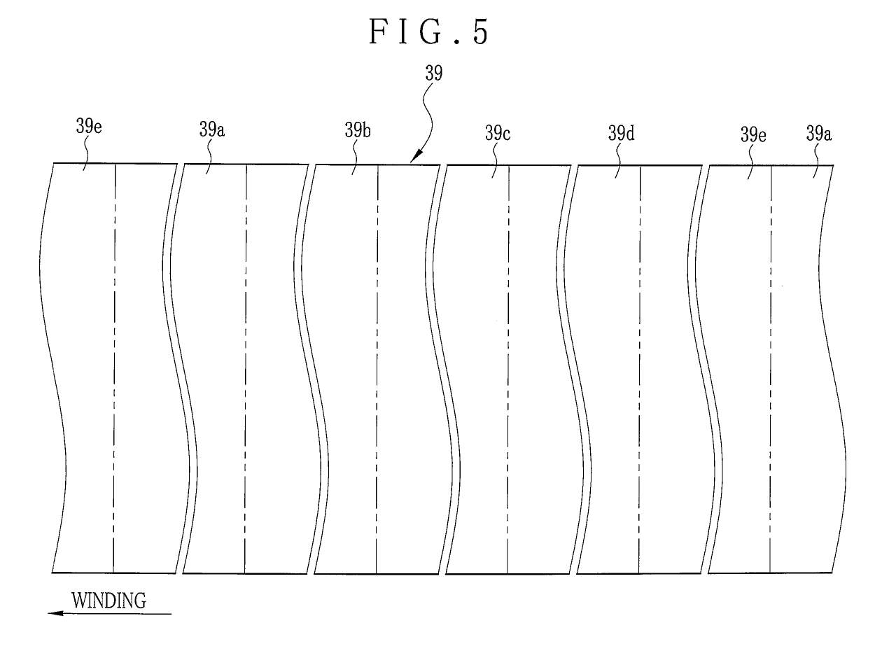

In FIG. 5, the ink film 39 includes a plastic support film, a receiving material area 39a, a yellow ink area 39b, a magenta ink area 39c, a cyan ink area 39d, and a back layer area 39e. The support film is long and has a width equal to that of the recording area of the lenticular sheet 13 in the main scan direction. The plural areas 39a-39e are formed on the support film, and repeated regularly for consecutive printing. A dimension of the plural areas 39a-39e in the sub scan direction is equal to that of the recording area on the lenticular sheet 13 in the sub scan direction. A recording size of each of the plural areas 39a-39e is equal to that of the lenticular sheet 13.

The receiving material area 39a is constituted by transparent receiving material supported on the plastic film, and superimposed on the back surface 19 and heated by the heating element arrays 38a to transfer the receiving material to the back surface 19. The receiving material is transferred to the entirety of the recording area, to form the receiving layer for depositing color ink. Although it is impossible to print an image with color ink on the lenticular sheet 13 on which color ink is difficult to deposit characteristically, the receiving material area 39a is used initially to apply a coating of the receiving material, which enables image forming reliably.

The yellow ink area 39b is constituted by yellow ink supported on the plastic film. The magenta and cyan ink areas 39c and 39d are constituted by magenta and cyan ink supported on the plastic film. The yellow, magenta and cyan ink is heated and sublimated by the heating element arrays 38a while superimposed on the back surface 19, and becomes deposited on the receiving layer. An amount of the ink, namely density of an image to be printed on the receiving layer, is suitably adjusted with an increase or decrease according to a heat amount of the heating.

The back layer area 39e is constituted by white ink supported on the plastic film, and superimposed on the back surface 19 and heated by the heating element arrays 38a to transfer the white ink to the receiving layer or ink layers. The white ink becomes a white back layer behind the receiving layer or ink layers, as a liner closing the through regions where the yellow, magenta or cyan ink is absent.

The film supply device 40 includes a supply spool 43, a winding spool 44, support rollers 45, and a winding motor 46. The supply spool 43 supports a roll of the ink film 39. The winding spool 44 is so disposed that the printhead 38 lies between the winding spool 44 and the supply spool 43. The support rollers 45 support the ink film 39 on both sides of the printhead 38. The winding motor 46 rotates the winding spool 44 in a winding direction. As the winding spool 44 rotates in synchronism with the transport of the lenticular sheet 13 in the array direction of the arrow B, the ink film 39 is unwound from the supply spool 43 and wound by the winding spool 44.

In FIG. 1, a printhead driver 49 drives the image forming assembly 37. To form the receiving layer and back layer on the back surface 19 of the lenticular sheet 13, the printhead driver 49 drives the printhead 38 so that heating elements simultaneously generate heat of a heat amount required for transferring receiving material and white ink. Also, the printhead driver 49 drives the printhead 38 according to input image data for image forming by use of the ink areas 39b, 39c and 39d of the ink film 39. Images of yellow, magenta and cyan are recorded in a frame sequential manner.

A data converter 52 inputs image data to the printhead driver 49. Two images with parallax are input by use of an I/O port (not shown) or memory card. The data converter 52 processes the images by image processing, and creates six images having parallax. Image data of the six images are input to the printhead driver 49.

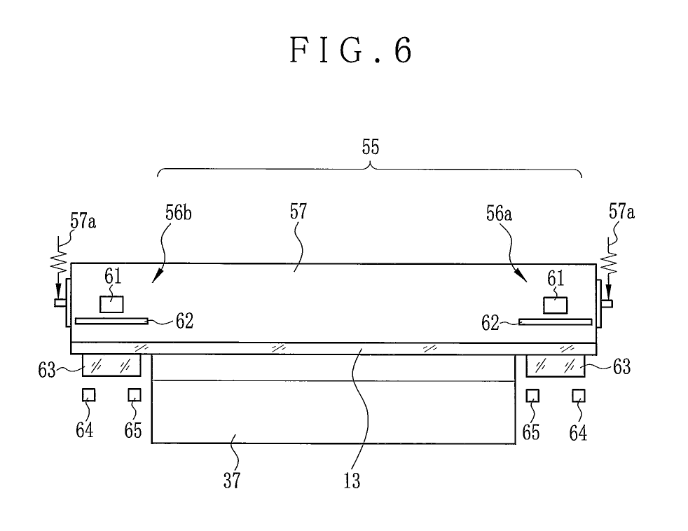

In FIG. 1, an orientation detector 55 is disposed higher than the image forming assembly 37, and is offset from the same in the main scan direction, and detects an orientation of the lenticular sheet 13. In FIG. 6, the orientation detector 55 is viewed through the exit slot 14, and includes detection units 56a and 56b and pressure rollers 57 and 58 as a pressure unit. The detection units 56a and 56b are opposed to respectively edge portions along lateral edges of the lenticular sheet 13 as viewed in the main scan direction. The pressure rollers 57 and 58 are arranged higher than the lenticular sheet 13 and in the sub scan direction (B) so that the detection units 56a and 56b are positioned between those.

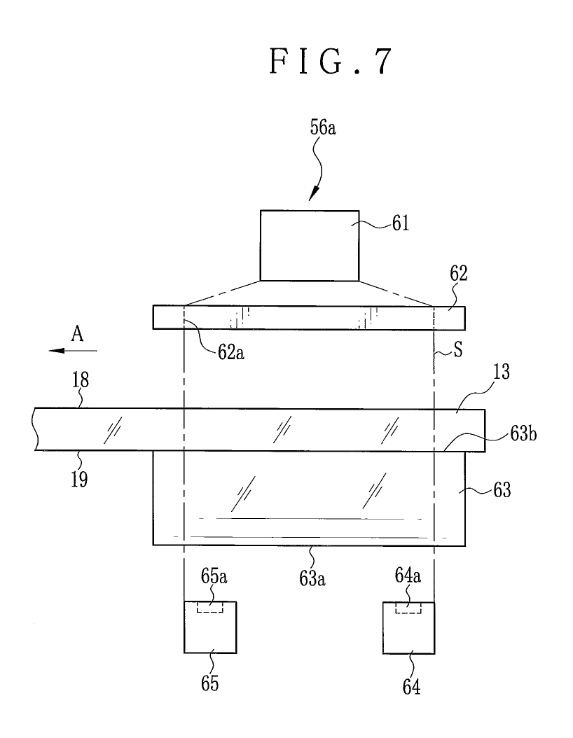

In FIG. 7, the detection unit 56a is viewed in the sub scan direction, and includes a projecting light source 61, a slit plate 62, a cylindrical lens 63 and line sensors 64 and 65. The projecting light source 61 is disposed higher than the transport channel 12. An example of the projecting light source 61 is a semiconductor laser or LED (light-emitting diode) which applies detection light S to the lens surface 18 of the lenticular sheet 13. A wavelength of the detection light S is 600-1,000 nm with which only low diffusion occurs on the lenticular sheet 13, so as to carry out the detection effectively even with the line sensors of low sensitivity.

The slit plate 62 is disposed between the projecting light source 61 and the transport channel 12 for shielding light. A slit 62a shaped in a rectangular quadrilateral is formed in the slit plate 62. A longer side of the slit 62a is directed in the main scan direction. The cylindrical lens 63 is disposed under the lenticular sheet 13 and oriented longitudinally in the main scan direction. The cylindrical lens 63 is a plano-convex cylindrical lens, and has a convex surface 63a of a cylindrical form and a plano surface 63b. The plano surface 63b is flush with the back surface 19 of the lenticular sheet 13 during passage.

Sensor elements 64a and 65a or pixels are arranged in a sub scan direction (element array direction) within respectively the line sensors 64 and 65 as CCD line sensors. The line sensors 64 and 65 are opposed to ends of the cylindrical lens 63 as viewed in its longitudinal direction under the cylindrical lens 63. Centers of the arrays of the sensor elements 64a and 65a are registered with the point on the optical axis of the cylindrical lens 63.

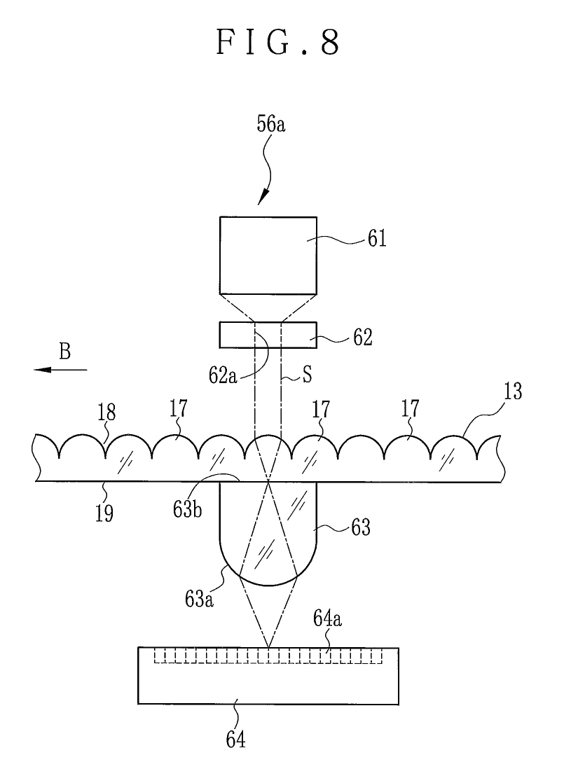

In FIG. 8, the detection unit 56a is viewed in the main scan direction. A size of the slit 62a of the slit plate 62 in the sub scan direction is approximately equal to a width of one of the lenticules 17. Detection light S emitted by the projecting light source 61 is shaped by the slit 62a into a line form of light extending in the main scan direction. The detection light S passed through the lenticular sheet 13 is diffused by the lenticules 17, but condensed in a linear shape by the cylindrical lens 63 of which a size in the sub scan direction is larger than that of the lenticules 17. The condensed detection light S becomes incident upon the line sensors 64 and 65.

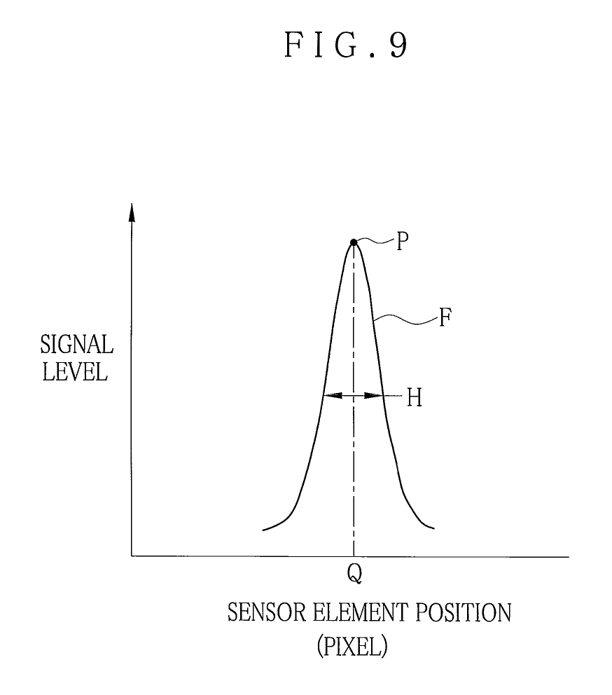

The line sensors 64 and 65 generate a detection signal of an analog form according to the received detection light S. An A/D converter in each of the line sensors 64 and 65 converts the detection signal into a digital detection signal. In FIG. 9, the detection signal F from the line sensors 64 and 65 is output in a waveform in a graph defined by a horizontal axis for the positions of the sensor elements in the line sensors 64 and 65 and by a vertical axis for the signal level of the output signal of the sensor elements. A sensor element position Q according to the peak value P of the waveform is a vertex point of one of the lenticules 17.

The detection light S emitted by the cylindrical lens 63 is shifted in the array direction by the transport of the lenticular sheet 13. When the lenticular sheet 13 finely rotates about a normal line of the two-dimensional plane tangential to the lens surface 18, the detection light S also rotates. A shift amount of the detection light S detected by the line sensors 64 and 65 can be detected with high precision no matter how finely the lenticular sheet 13 moves, because of the enlargement with the cylindrical lens 63.

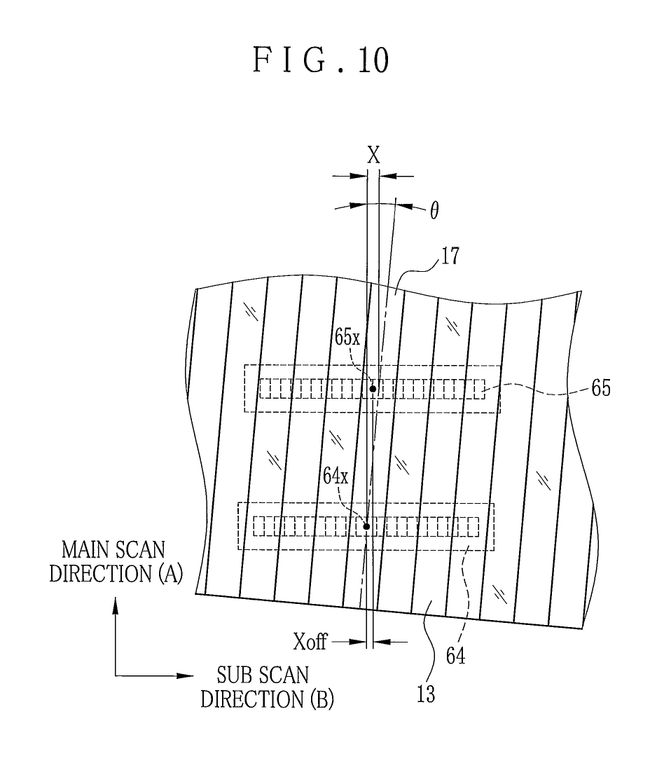

The line sensors 64 and 65 are associated with respectively the detection units 56a and 56b for the purpose of detecting a peak point of detection light S passed through the point on the optical axis of the cylindrical lens 63. As described above, the line sensors require attaching by registering their sensor element centers with the point on the optical axis of the cylindrical lens 63. However, there occur errors in sensor element centers 64x and 65x due to errors in positioning. See FIG. 10.

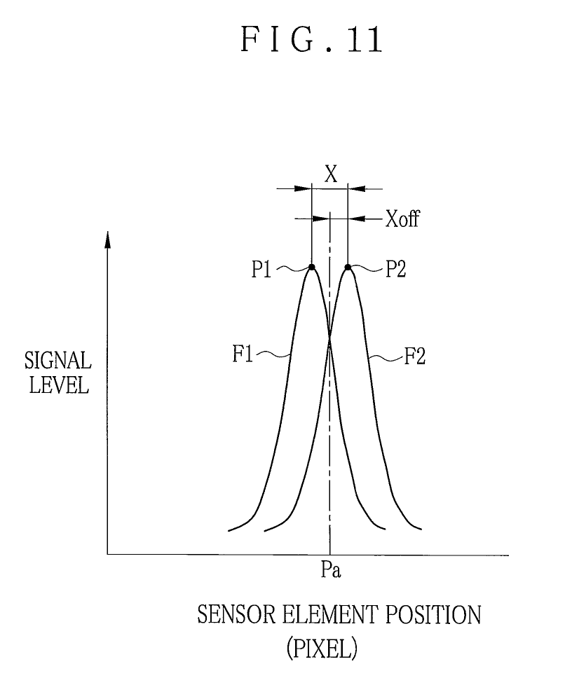

In the embodiment, the offset amount Xoff is predetermined for the sensor element centers 64x and 65x of the line sensors 64 and 65, and is subtracted from a difference X between the detection signals F1 and F2 of the line sensors 64 and 65 in FIG. 11, so that a peak point Pa is obtained for a peak point of the detection light S passed through the point on the optical axis of the cylindrical lens 63. Note that the peak point Pa can be determined also by adding the offset amount Xoff to the detection signal F1 of the line sensor 64, or by subtracting the offset amount Xoff from the detection signal F2 of the line sensor 65.

The detection unit 56b is structurally equal to the detection unit 56a, and detects a peak point Pb of the detection light S passed through the optical center of the cylindrical lens 63 in the same manner as the detection unit 56a. For the detection unit 56b, see the detailed description of the detection unit 56a above.

The pressure rollers 57 and 58 are arranged in the main scan direction, and have a length approximately equal to a width of the lenticular sheet 13 in the main scan direction. The pressure rollers 57 and 58 are kept movable up and down. Springs 57a and 58a bias respectively the pressure rollers 57 and 58 down for contact with the lens surface 18 of the lenticular sheet 13. The pressure rollers 57 and 58 are rotated by the transport of the lenticular sheet 13, and press the back surface 19 against the plano surface 63b of the cylindrical lens 63. This is effective in preventing diffusion of the detection light S away from the back surface 19 and a drop of the light amount, in order to increase precision in the detection. Also, the pressure rollers 57 and 58 operate as platen devices for supporting the lenticular sheet 13 in the image forming.

A controller 59 of FIG. 1 has such elements as CPU, ROM, RAM, drivers and the like. The CPU performs arithmetic tasks according to control programs. The ROM stores the control programs. The RAM is a working memory for storing various data temporarily during the control. The drivers drive respectively the motors, the projecting light source, the line sensors and the like. The controller 59 controls various elements of the printer 10.

The controller 59 counts passed ones of the lenticules 17 according to outputs of the line sensors 64 and 65 of the detection units 56a and 56b, and detects a present position of the lenticular sheet 13. A start position for printing to the back surface 19 is determined. Also, the controller 59 determines a direction of an inclination of the lenticules 17 relative to the main scan direction to obtain an angle θ of the inclination according to the peak points Pa and Pb from the detection units 56a and 56b and a distance W between the detection units 56a and 56b.

The controller 59 controls the transport device 29 according to the direction of the inclination of the lenticules 17 and the angle θ of its inclination to set a difference in the speed between the transport roller sets 29a and 29b. Thus, the rates of moving the lateral edges of the lenticular sheet 13 are different from one another. The lenticular sheet 13 is finely rotated about the axis being perpendicular to the two-dimensional plane tangential to the lens surface 18. So the longitudinal direction of the lenticules 17 becomes aligned with the main scan direction.

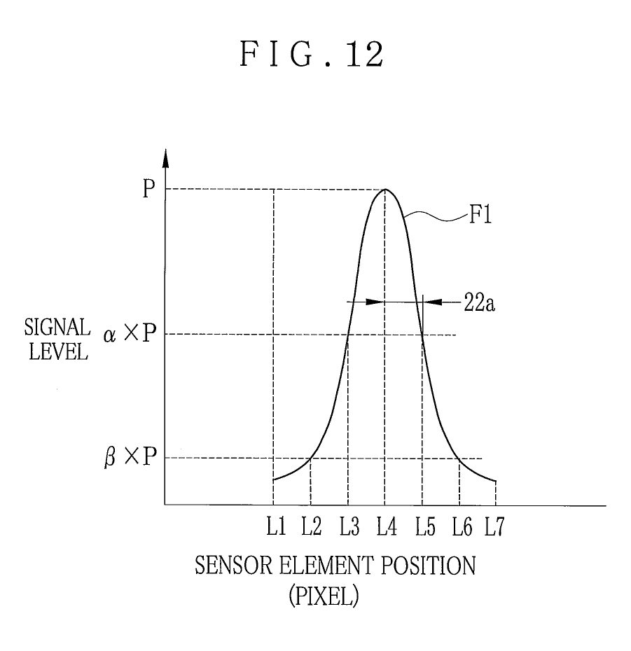

The controller 59 determines the positions of the data regions 22a of the back surface 19, and causes the image forming assembly 37 to print dots of yellow, magenta and cyan colors for positions of the data regions 22a. In FIG. 12, the controller 59 determines a peak value P from a waveform of the detection signal F1 of the line sensor 64 after adjusting the orientation of the lenticular sheet 13. The controller 59 multiplies the peak value P by predetermined coefficients α and β, to obtain six of the data regions 22a according to the sensor element positions L1-L7 associated with determined levels of the waveform. It is possible to print dots according to the lenticules 17 in the lenticular sheet 13 suitably even with specificity in the form of the lenticules 17.

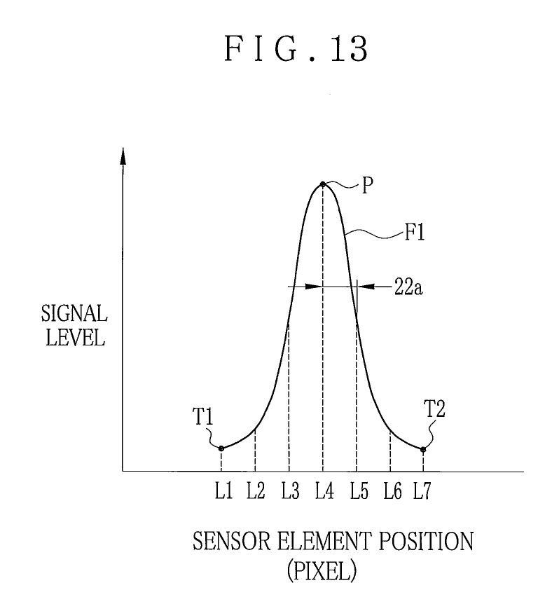

It is possible to divide the waveform of the detection signal F1 equally in the element array direction for the purpose of determining the data regions 22a. In FIG. 13, the peak value P and the minimum values T1 and T2 are obtained from the waveform of the detection signal F1. Let L1, L4 and L7 be sensor element positions corresponding to the values P, T1 and T2. Sections between the positions L1 and L4 and between the positions L4 and L7 are equally divided, to obtain sensor element positions L2, L3, L5 and L6. Thus, it is possible to determine the six data regions 22a.

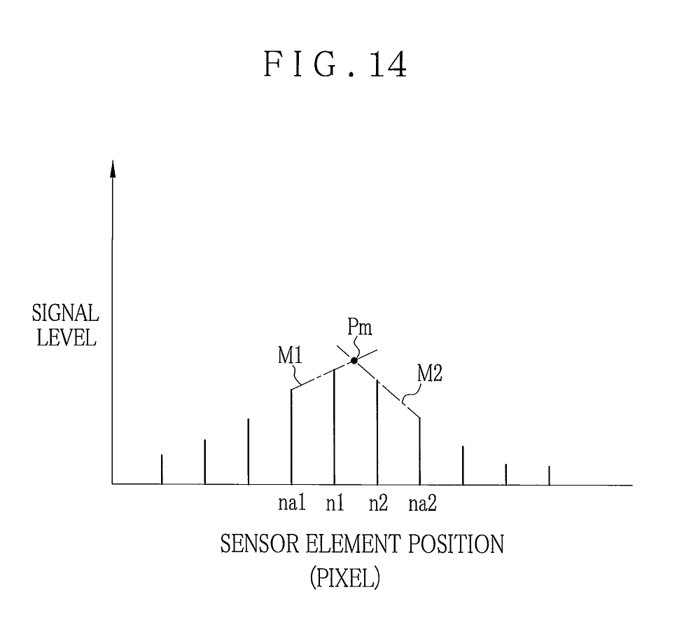

The controller 59 detects a vertex point of one of the lenticules 17 at a smaller pitch than the sensor element pitch of the line sensors 64 and 65. In FIG. 14, a situation without a large difference between the output values of the sensor elements n1 and n2 is illustrated. There is no distinct peak value of the detection signal. The controller 59 determines a first sensor element n1 with a highest output value and a second sensor element n2 with a second highest output value. Then a first tangent M1, passing the first sensor element n1 and a third sensor element na1 adjacent to the first sensor element n1, is drawn. A second tangent M2, passing the second sensor element n2 and a fourth sensor element na1 adjacent to the second sensor element n2, is drawn. A sensor element position Q1 is retrieved in association with an intersection point Pm of the first tangent M1 and the second tangent M2, and is determined as a vertex point of the lenticule 17. It is possible to detect the lenticule 17 of the lenticular sheet 13 with a smaller pitch by use of a line sensor even having the large pitch of sensor elements.

The operation of the printer 10 of the present embodiment is described now. When the lenticular sheet 13 is supplied through the inlet slot 11, the controller 59 controls the supply rollers 25 to nip the lenticular sheet 13. The supply motor 26 is controlled to move the lenticular sheet 13 into the transport channel 12.

The controller 59 drives the detection units 56a and 56b upon detection of a distal end of the lenticular sheet 13 with the end sensor 30, and starts counting passed ones of the lenticules 17 according to detection signals from the line sensors 64 and 65. The controller 59, when the count of the passed ones of the lenticules 17 reaches a prescribed number, stops transporting the lenticular sheet 13 with the supply rollers 25. The transport roller sets 29a and 29b are caused by the controller 59 to nip the lenticular sheet 13. Also, the supply rollers 25 are shifted to release the lenticular sheet 13 from being nipped.

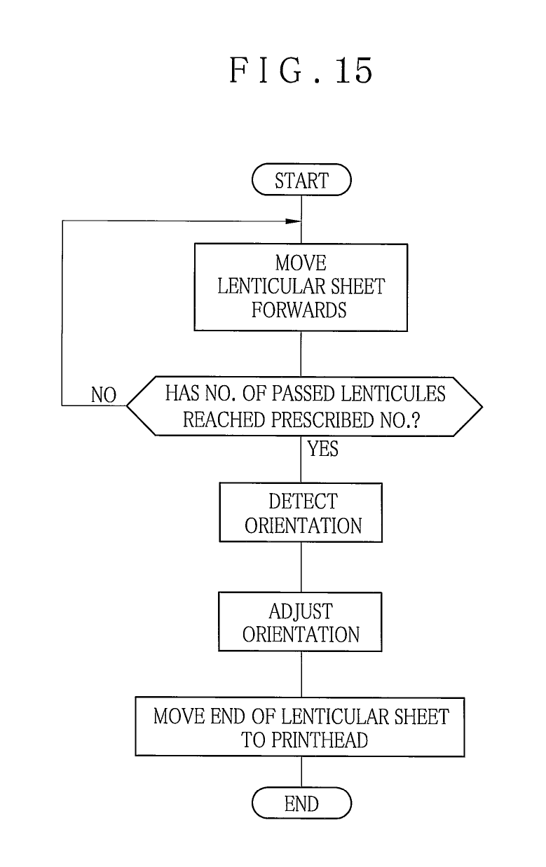

In FIG. 15, the controller 59 causes the transport roller sets 29a and 29b to rotate at an equal speed, and transport the lenticular sheet 13 intermittently in the forward direction. The controller 59 starts up the detection units 56a and 56b at the same time as the lenticular sheet 13 starts the transport, to count the number of passed ones of the lenticules 17 according to detection signals from the line sensors 64 and 65.

The controller 59, when the count of the passed ones of the lenticules 17 reaches the prescribed number, determines a direction and angle θ of an inclination of the lenticules 17 relative to the main scan direction according to detection signals from the line sensors 64 and 65. Note that the detection signals obtained in an inactive step during the intermittent transport of the lenticular sheet 13 are used for high precision in determining the direction and angle θ of the inclination according to a stabilized waveform of the detection signals.

The controller 59 determines the rotational speeds different from one another for the transport roller sets 29a and 29b according to the direction and angle θ of the inclination of the lenticules 17, and adjusts the direction of the lenticular sheet 13 in the transport to align the lenticules 17 with the main scan direction.

The controller 59 rotates the transport roller sets 29a and 29b at an equal speed to move the lenticular sheet 13 intermittently in the forward direction, and starts counting passed ones of the lenticules 17 according to detection signals from the line sensors 64 and 65. The controller 59 determines one position of the data regions 22a of the back surface 19 according to a detection signal F1 from the line sensor 64. When the count of the passed ones of the lenticules 17 reaches a prescribed number, the controller 59 determines that a distal end of a recording area of the lenticular sheet 13 has reached the printhead 38, and drives the image forming assembly 37 to form a receiving layer on the back surface 19.

After the receiving layer is formed, the controller 59 transports the lenticular sheet 13 in the backward direction, counts the number of passed ones of the lenticules 17 according to the detection signal, and stops the transport upon reach of a recording area on the printhead 38. Again, the controller 59 transports the lenticular sheet 13 in the forward direction, and drives the image forming assembly 37 for image forming of stripe-shaped interlaced images of yellow. In the image forming of yellow, the controller 59 prints the interlaced images within designated ones of the data regions 22a according to the detection signal F1.

The controller 59 changes over the transport of the lenticular sheet 13 between the forward and backward directions, and performs a task of printing interlaced images of magenta and cyan on the back surface 19. To this end, the data regions 22a of which the position is determined according to the detection signal are used for positioning. Finally, the controller 59 operates for forming a back layer on the back surface 19. The lenticular sheet 13 finished as a three dimensional print with the back layer is discharged through the exit slot 14 to the outside of the printer 10.

Other preferred embodiments are hereinafter described. Elements similar to those of the above embodiment are designated with identical reference numerals.

### 2nd Embodiment

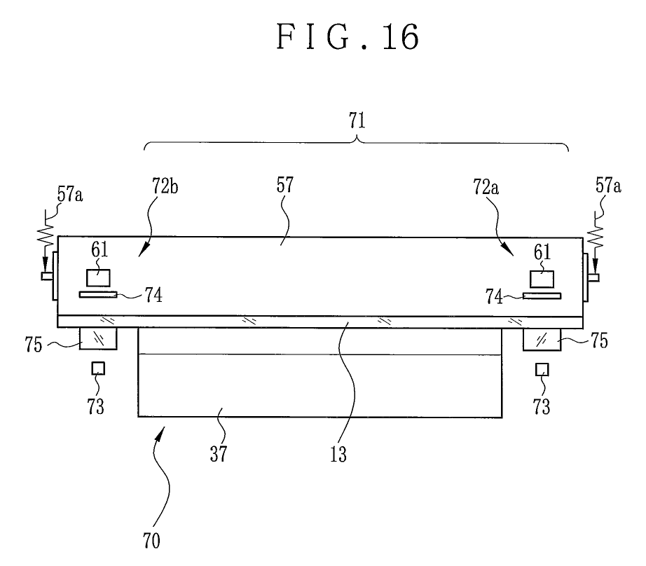

In the first embodiment, the line sensors 64 and 65 are incorporated in each of the detection units 56a and 56b. In contrast, a second preferred printer 70 is illustrated in FIG. 16, in which one line sensor 73 is incorporated in detection units 72a and 72b which constitute an orientation detector 71. A slit plate 74 has a smaller size than the slit plate 62 in the main scan direction. A cylindrical lens 75 has a smaller size than the cylindrical lens 63 in the main scan direction. This structure makes it possible to reduce a size of the printer 70.

The printer 70 of the embodiment controls the transport device 29 to match the sensor element positions of the peak values P of the detection signals from the line sensor 73 of the detection units 72a and 72b. In FIG. 11, let F1 and F2 be the detection signals from the line sensor 73 of the detection units 72a and 72b. Let X be a difference between the sensor element positions of the peak values P1 and P2 of the detection signals F1 and F2. The controller 59 adjusts the transport speed of the transport roller sets 29a and 29b by monitoring a difference between the peak values P1 and P2, so as to match the sensor element positions of the peak values P1 and P2 with one another. This is effective in directing the lenticules 17 longitudinally in the main scan direction.

It is possible in the printer 70 to determine the direction and angle of the inclination of the lenticules 17 relative to the main scan direction from detection signals of the line sensor 73 of the detection units 72a and 72b in a manner similar to the first embodiment. The orientation of the lenticular sheet 13 can be adjusted according to the result of the determination.

### 3rd Embodiment

In the first and second embodiments, the orientation is detected and adjusted according to the detection signal of one of the lenticules 17. However, it is possible to detect and adjust the orientation according to detection signals of two of the lenticules 17.

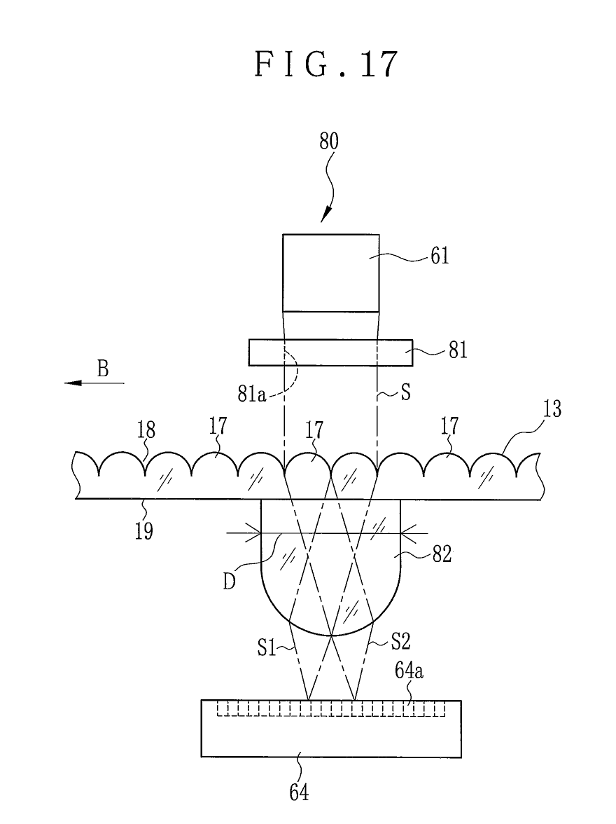

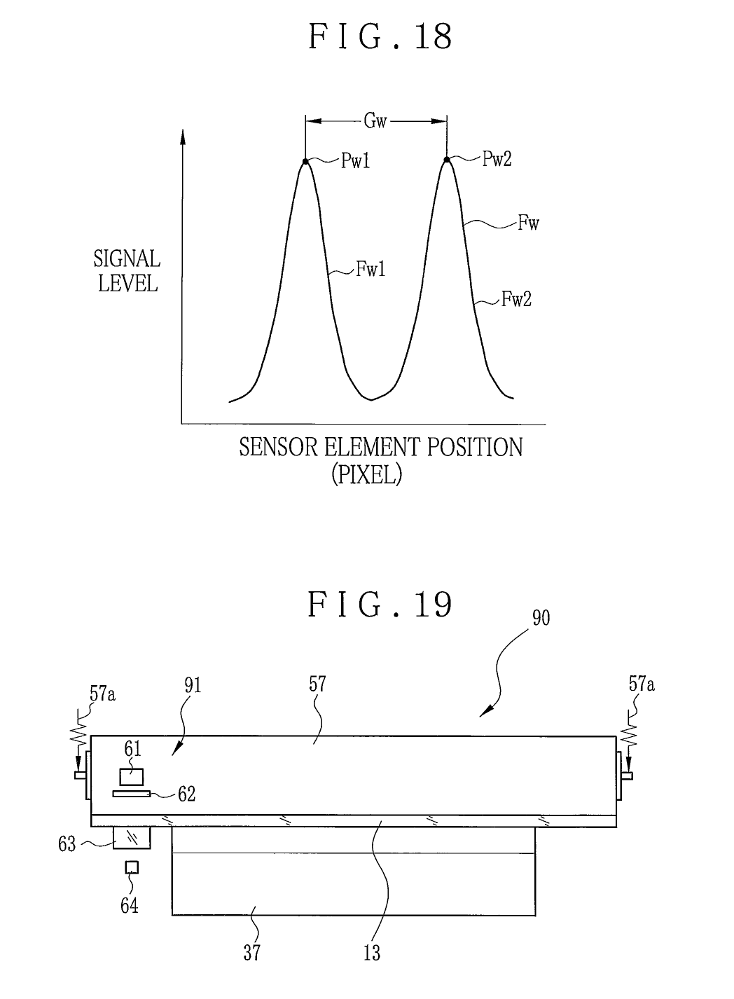

In FIG. 17, a printer of the embodiment has a detection unit 80 including a slit plate 81 and a cylindrical lens 82. A slit 81a is formed in the slit plate 81 for applying the detection light S to two of the lenticules 17 simultaneously. Two light components S1 and S2 of the detection light are obtained by diffusion in the two of the lenticules 17. The cylindrical lens 82 is disposed with a size D in the sub scan direction suitable for condensing the two light components S1 and S2. As the detection light components S1 and S2 are incident upon the line sensor 64, a detection signal Fw output by the line sensor 64 has two waveforms Fw1 and Fw2 corresponding to the two of the lenticules 17 and two peak values Pw1 and Pw2. See FIG. 18.

In the first embodiment, errors are likely to occur with influence of irregularity in transporting the lenticular sheet 13 because of counting each passed one of the lenticules 17 for the purpose of controlling the positioning. In the second embodiment, in contrast, two of the lenticules 17 are counted simultaneously to reduce influence of irregularity in transporting the lenticular sheet 13. This is effective in precisely controlling the positioning of the lenticular sheet 13.

It is possible in the printer to determine the direction and angle of the inclination of the lenticules 17 by use of the detection units 56a and 56b in a manner similar to the first embodiment. The interval Gw between the peak values Pw1 and Pw2 can be used for the angle. It is also possible to control the transport device to align two peak values of the detection signal in an element array direction in the manner of the second embodiment. Note that the two peak values are obtained from the waveforms Fw1 and Fw2 corresponding to one of the lenticules 17 in case of using the detection signal of the line sensor with the sensor elements at a large pitch.

### 4th Embodiment

In contrast with the above embodiments where the two detection units are used, only one detection unit may be used for the orientation detection and orientation adjustment of the lenticular sheet 13. In FIG. 19, a printer 90 includes one detection unit 91 opposed to one lateral edge portion of the lenticular sheet 13. The detection unit 91 has the projecting light source 61, the slit plate 62, the cylindrical lens 63 and the line sensor 64.

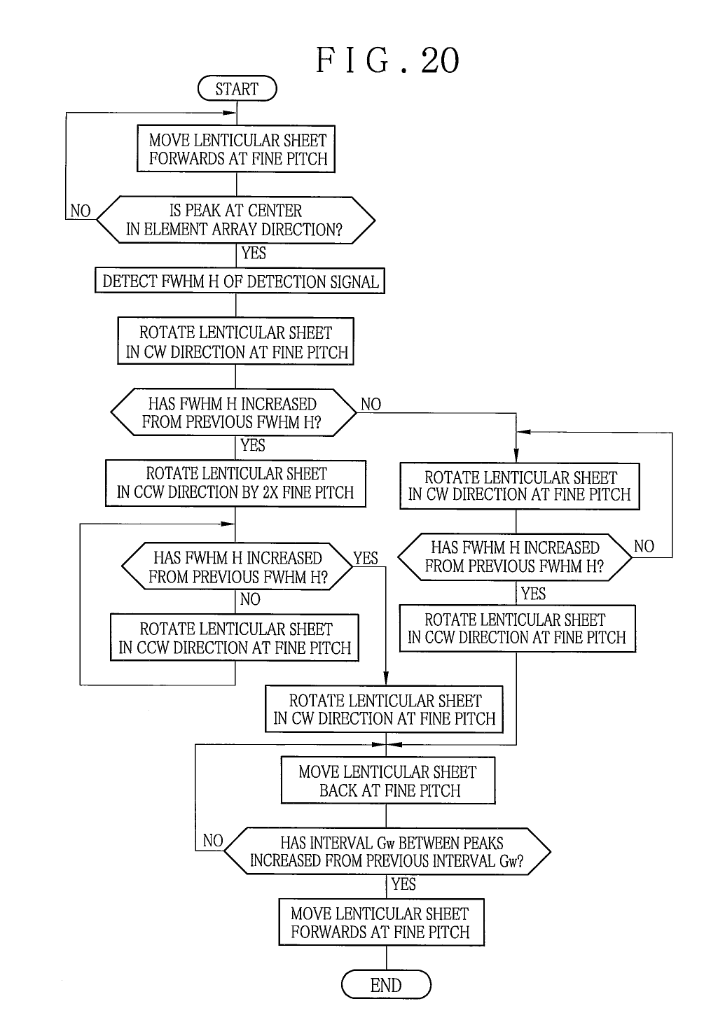

In FIG. 20, the controller 59 drives the transport roller sets 29a and 29b to nip the lenticular sheet 13. The transport motor 32 is driven to rotate at the smallest pitch (fine pitch) of rotation, to transport the lenticular sheet 13 in the forward direction. After the lenticular sheet 13 is transported, the controller 59 monitors a detection signal of the line sensor 64 to check whether a peak value is at the center of the element array direction or not.

In FIG. 9, the controller 59 detects a full width at half maximum H (FWHM) from the detection signal F when the peak value of the detection signal comes at the center in the element array direction. The full width at half maximum H is the shortest when the lenticules 17 extend in parallel with the main scan direction, but increases according to an increase in the angle of its inclination relative to the main scan direction.

The controller 59 causes the transport motor 32 to rotate at the smallest pitch of rotation in the backward direction, to move the lenticular sheet 13 rotationally at the smallest pitch in a clockwise direction as viewed downwards. After the lenticular sheet 13 is rotated in the clockwise direction, the controller 59 detects the full width at half maximum H again from the detection signal F, and determines an increase or decrease relative to a previous value of the full width at half maximum H.

If the full width at half maximum H increases, it is found that the lenticules 17 are inclined in the clockwise direction relative to the main scan direction. Thus, the controller 59 causes the lenticular sheet 13 to rotate in the counterclockwise direction by an amount two times as much as the smallest pitch, and carries out the detection of the full width at half maximum H again. If the full width at half maximum H becomes smaller than its former value, the controller 59 repeats a sequence including rotation of one step in the counterclockwise direction and detection of the full width at half maximum H until next start of the increase in the full width at half maximum H. When the full width at half maximum H increases, the lenticular sheet 13 rotates in the clockwise direction by one step of the smallest pitch. Thus, the full width at half maximum H of the detection signal F becomes the minimum.

If the full width at half maximum H decreases after the initial rotation in the clockwise direction, the lenticules 17 are found inclined in the left direction or counterclockwise direction relative to the main scan direction. The controller 59 causes the lenticular sheet 13 to rotate by one step of the smallest pitch in the clockwise direction, to detect the full width at half maximum H again. If there is a further decrease in the full width at half maximum H from its previous level, then the controller 59 repeats a sequence of rotation of the smallest pitch in the clockwise direction and detection of the full width at half maximum H until there occurs an increase in the full width at half maximum H. Upon occurrence of an increase in the full width at half maximum H, the lenticular sheet 13 is caused to rotate by one step of the smallest pitch in the counterclockwise direction. Thus, the full width at half maximum H of the detection signal F becomes the smallest.

After adjusting the orientation of the lenticular sheet 13, the controller 59 rotates the transport motor 32 in the same direction at the smallest pitch of rotation, to move the lenticular sheet 13 in the backward direction. The controller 59 detects the full width at half maximum H of the detection signal F, and if the full width at half maximum H becomes smaller than its former level, repeats the backward movement of one step and the detection of the full width at half maximum H until a succeeding increase of the full width at half maximum H. When the full width at half maximum H increases, the lenticular sheet 13 is moved forwards by one step. Thus, a vertex point of one of the lenticules 17 becomes disposed at the sensor element center of the line sensor 64. Then images are printed on the back surface 19 in the same manner as the first embodiment.

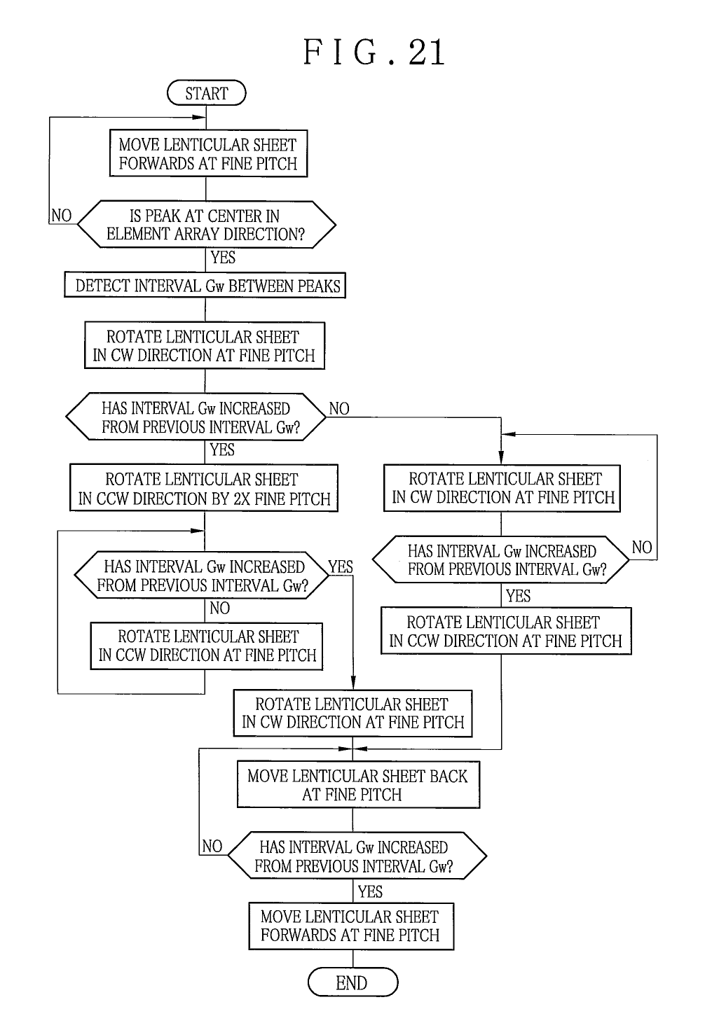

In the embodiment, it is possible to detect and adjust the orientation of the lenticular sheet 13 with one detection unit. A size of the printer can be reduced to reduce the manufacturing cost. In the above embodiment, the full width at half maximum H of the detection signal F is used for detecting and adjusting the orientation of the lenticular sheet 13. Alternatively, a detection signal Fw of FIG. 21 can be used for the same purpose. The detection signal Fw has two peak values Pw1 and Pw2. The orientation of the lenticular sheet 13 can be detected and adjusted according to an interval Gw between the two peak values Pw1 and Pw2.

In the above embodiment, the method of the image forming in the image forming assembly 37 is thermal recording. However, other methods of image forming can be used in the invention, such as ink-jet printing, electrophotography, and the like. Image forming material for transfer to the lenticular sheet 13 is the ink from the thermal transfer ink film, but may be other materials such as toner, pigment, dye and the like.

In the above embodiment, the number of the data regions is six. However, five or less stripe-shaped data regions, or seven or more stripe-shaped data regions (interlaced images) can be formed per one linear area (lenticule). The number of the data regions per linear area can be an integer times as much as the number of the original images.

In the above description, the four embodiments are discrete from one another. Furthermore, one or more of the four embodiments can be combined with one another.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A printer for printing with a lenticular sheet including an array of plural lenticules and a back surface located opposite to said lenticules, comprising:
a transport device for transporting said lenticular sheet in a transport channel extending in a first direction, said transport device being adapted to correcting an orientation of said lenticular sheet to align said lenticules with a second direction perpendicular to said first direction;
a printhead for printing plural interlaced images on said back surface in a second direction in said lenticular sheet through said transport channel, said interlaced images being formed by interlacing two or more original images having disparity;
a projecting light source for applying slit-shaped detection light extending in said second direction to said lenticules of said lenticular sheet in said transport channel;
a plano-convex cylindrical lens disposed opposite to said projecting light source with respect to said transport channel, having a convex surface and a plano surface, said convex surface extending in said second direction, said plano surface being opposed to said back surface;
a pressure unit for firmly pressing said back surface on said plano surface;
a line sensor, having plural sensor elements arranged in said first direction, for receiving detection light condensed by said cylindrical lens, to output a detection signal for representing a vertex point of said lenticules;
a controller for controlling said transport device according to said detection signal, for correcting said orientation, and for controlling said printhead for printing.

2. A printer as defined in claim 1, wherein said projecting light source applies said detection light to plural adjacent lenticules among said lenticules;
said cylindrical lens condenses two or more detection light components obtained by splitting said detection light with said adjacent lenticules;
said line sensor receives said detection light components being condensed, and outputs said detection signal to represent said vertex point of said adjacent lenticules.

3. A printer as defined in claim 1, wherein said transport device transports said lenticular sheet intermittently, and said printhead accesses to said lenticular sheet while said lenticular sheet is stopped.

4. A printer as defined in claim 3, wherein said transport device includes:
a right transport unit for transporting a right portion of said lenticular sheet; and
a left transport unit for transporting a left portion of said lenticular sheet, and for operating discretely from said right transport unit.

5. A printer as defined in claim 4, wherein said controller sets a difference in an amount of transport between said right and left transport units according to said detection signal obtained while said lenticular sheet is stopped, to correct said orientation.

6. A printer as defined in claim 5, wherein said right and left transport units are pairs of transport rollers for nipping said lenticular sheet.

7. A printer as defined in claim 5, wherein said projecting light source and said cylindrical lens are positioned to face respectively right and left edge portions of said lenticular sheet in said second direction;
said line sensor is constituted by first and second pairs of line sensors, disposed to extend in said first direction, and opposed to respectively first and second ends of said cylindrical lens; and
said controller determines a direction and angle of an inclination relative to said second direction according to said detection signal from said first and second pairs, and controls said transport device according to said determined direction and angle.

8. A printer as defined in claim 7, wherein said projecting light source, said cylindrical lens and one pair of said line sensors are so disposed that said printhead is disposed between first and second combinations thereof.

9. A printer as defined in claim 5, wherein a combination of said projecting light source, said cylindrical lens and said line sensor is opposed to each of right and left edge portions of said lenticular sheet in said second direction;
said controller controls said transport device according to said detection signal output by respectively said line sensor, and matches said vertex point between said right and left edge portions in said first direction.

10. A printer as defined in claim 1, wherein said controller finely rotates said lenticular sheet at a fine pitch in a two-dimensional plane defined by said first and second directions, detects a full width at half maximum of said detection signal, compares values of said full width at half maximum between time points before and after fine rotation of said lenticular sheet, repeats said fine rotation, detection of said full width at half maximum and comparison of said values, then changes over a direction of said fine rotation according to said comparison, and corrects said orientation during said transport by minimizing said full width at half maximum.

11. A printer as defined in claim 1, wherein said controller finely rotates said lenticular sheet at a fine pitch in a two-dimensional plane defined by said first and second directions, detects an interval between vertex points of two of said lenticules according to said detection signal, compares values of said vertex point interval between time points before and after fine rotation of said lenticular sheet, repeats said fine rotation, detection of said vertex point interval and comparison of said values, then changes over a direction of said fine rotation according to said comparison, and corrects said orientation during said transport by minimizing said vertex point interval.

12. A printer as defined in claim 1, wherein said controller determines a region of one of said lenticules according to a position of said sensor elements in said line sensor and said detection signal of a relationship between outputs of said sensor elements;
determines first and second sensor elements of which signals at a highest signal level and a second highest signal level are output in said region;
obtains a first tangent passing points of signal levels of said first sensor element and a third sensor element disposed adjacent thereto, and a second tangent passing points of signal levels of said second sensor element and a fourth sensor element disposed adjacent thereto; and
retrieves said vertex point of said one lenticule from an intersection point between said first and second tangents.

13. A printer as defined in claim 1, wherein said detection light has a wavelength equal to or more than 600 nm and equal to or less than 1,000 nm.

14. A printer as defined in claim 13, wherein said controller counts a number of passed ones of said lenticules according to said detection signal to obtain a position of said lenticular sheet, and determines a start position for printing.

15. A printer as defined in claim 5, wherein said controller determines a data region for one of said interlaced images according to a waveform of said detection signal.

16. A printer as defined in claim 5, wherein said controller determines a peak value from said waveform according to one of said lenticules in said detection signal, multiplies said peak value by at least one coefficient determined according to a number of said interlaced images per said one lenticule, and determines said data region for said one interlaced image according to a sensor element position of one of said sensor elements in association with a signal level obtained from a result of multiplication.

17. A printer as defined in claim 5, wherein said controller determines a peak point with a highest signal level and first and second points between which said peak point is disposed and which has a lowest signal level, from said waveform according to one of said lenticules in said detection signal, then equally divides a section between said first point and said peak point and a section between said second point and said peak point, and determines said data region for said one interlaced image.

18. A printer as defined in claim 5, wherein said pressure unit constitutes a platen device for supporting said lenticular sheet during printing of said printhead to said back surface.

19. A printer as defined in claim 5, wherein said printhead operates according to transfer recording.

20. A printer as defined in claim 19, wherein said transfer recording is thermal transfer recording for use with thermal transfer ink film.

21. A printing method for a lenticular sheet including an array of plural lenticules and a back surface located opposite to said lenticules, comprising:
transporting said lenticular sheet in a transport channel extending in a first direction;
applying slit-shaped detection light extending in a second direction perpendicular to said first direction to said lenticules of said lenticular sheet in said transport channel;
condensing said detection light passed from said back surface by use of a plano-convex cylindrical lens having a convex surface and a plano surface, said convex surface extending in said second direction, said plano surface contacting said back surface;
receiving said detection light passed from said convex surface of said cylindrical lens by use of a line sensor, to output a detection signal for representing a vertex point of said lenticules, said line sensor having plural sensor elements arranged in said first direction;
correcting an orientation of said lenticular sheet to align said lenticules with said second direction according to said detection signal;
printing plural interlaced images on said back surface in said second direction in said lenticular sheet while said lenticular sheet is stopped, said interlaced images being formed by interlacing two or more original images having disparity.

22. A printing method as defined in claim 21, wherein said detection light is applied to plural adjacent lenticules among said lenticules;
said cylindrical lens condenses two or more detection light components obtained by splitting said detection light with said adjacent lenticules;
said line sensor receives said detection light components being condensed, and outputs said detection signal to represent said vertex point of said adjacent lenticules.
